(19) United States
(12) Patent Application Publication
(10) Pub. No.: US 2026/0081373 A1
(43) Pub. Date: Mar. 19, 2026

(54) AUTO LOCK CONNECTOR

(71) Applicant: HAMBURG (JIANGSU) CO., LTD., Huaian (CN)

(72) Inventor: Ya-Li HUANG, New Taipei City (TW)

(73) Assignee: HAMBURG (JIANGSU) CO., LTD., Huaian (CN)

(21) Appl. No.: 18/888,327

(22) Filed: Sep. 18, 2024

(51) Int. Cl. H01R 12/70; H01R 12/77; H01R 13/405

(52) U.S. Cl. CPC H01R 12/7029; H01R 12/777; H01R 13/405

(57) ABSTRACT

An auto lock connector is configured to connect a circuit unit. The circuit unit has at least one aperture. The auto lock connector has a casing, an insertion port, and at least one locking member. The insertion port is formed on the casing. The locking member is mounted in the casing, and each locking member has at least one pushing part, at least one protrusion part, and at least one connection part. The pushing part protrudes from the casing. The protrusion part is connected to the pushing part, protrudes upward, and is capable of mounting in a respective one of the at least one aperture. Each protrusion part has an incline inclined from a top surface of the protrusion part toward a bottom surface of the insertion port. The at least one connection part is elastic and configured to push the protrusion part toward a top surface of the casing.

### BACKGROUND OF THE INVENTION

### 1. Field of the Invention

The present invention relates to a connector, especially to an auto lock connector that is configured to lock a circuit unit.

### 2. Description of the Prior Arts

Flexible Flat Cable (FFC) is a material cable made of very thin tinned flat copper wire and PET insulation material through high precision automated assembly line. The FFC has the advantages of flexibility, arbitrary bending and folding, easy connection, easy disassembly, small size, and effective reduction of electromagnetic shielding (EMI). The Flexible Print Circuit (FPC) is a bendable circuit board using polyimide or polyester film as the substrate.

A conventional FFC/FPC connector is a lift-off connector. The lift-off connector comprises a cover and a base. When the user wants to insert the FFC or the FPC into the FFC/FPC connectors, the user needs to lift the cover, put in the FFC/FPC, and then close the cover, which is a cumbersome operation. In addition, the conventional FFC/FPC cannot be wrapped with hardware shielding material, which may cause external signals to interfere with the FFC/FPC transmission.

To overcome the shortcomings, the present invention provides an auto lock connector to mitigate or obviate the aforementioned problems.

### SUMMARY OF THE INVENTION

The main objective of the present invention is to provide an auto lock connector that enables the circuit unit to be directly placed and locked in the auto lock connector, reducing installation time.

The auto lock connector is configured to connect a circuit unit. The circuit unit is a flexible flat cable or a flexible print circuit and has at least one aperture. The auto lock connector has a casing, an insertion port, a terminal assembly, and at least one locking member.

The casing forms a compartment. The insertion port is formed on the casing, and the compartment communicates with the environment via the insertion port. The terminal assembly is mounted on the casing and configured to be electrically connected to the circuit unit.

The at least one locking member is mounted in the casing, and each one of the at least one locking member has at least one pushing part, at least one protrusion part, and at least one connection part.

The at least one pushing part protrudes from the casing. The at least one protrusion part is connected to the at least one pushing part, protrudes upward, and is capable of mounting in a respective one of the at least one aperture of the circuit unit. Each one of the at least one protrusion part has an incline inclined from a top surface of the protrusion part toward a bottom surface of the insertion port.

The at least one connection part is connected to the at least one pushing part and the casing, and the at least one connection part is elastic and thus configured to push the protrusion part toward a top surface of the casing.

Wherein, when the circuit unit is inserted into the casing from the insertion port, each one of the at least one protrusion part is inserted into a respective one of the at least one aperture of the circuit unit, so that the circuit unit is unable to be removed from the casing.

When the at least one pushing part of each one of the at least one locking member is pushed, the at least one protrusion part moves away from the top surface of the casing and is disengaged from the at least one aperture of the circuit unit, so that the circuit unit is capable of being pulled out from the casing.

The advantage of the present invention is that when the circuit unit is inserted into the casing, the circuit unit will be locked in the casing due to the recovery elasticity of the connection part to achieve automatic locking. Meanwhile, to avoid the circuit unit being pulled by external force and leaving the casing or damaging the circuit unit when the circuit unit is locked, the present invention also designs the angle between the horizontal segment and a respective one of the at least one protrusion part less than 90 degrees and has a retaining segment to protect the circuit unit. In terms of unlocking the circuit unit, the user only needs to press the at least one pushing part to disengage the at least one protrusion part from the at least one aperture of the circuit unit, and pull out the circuit unit. Whether installing or releasing the circuit unit, the operation is simple and can reduce the time spent on disassembly.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of an auto lock connector in the first embodiment in accordance with the present invention, shown with a circuit unit;

FIG. 2 is an exploded view of the auto lock connector in the first embodiment in FIG. 1;

FIG. 3 is a cross-sectional view of the auto lock connector in the first embodiment in FIG. 1;

FIG. 4 is a partial cross-sectional view of the auto lock connector in the first embodiment in FIG. 1;

FIG. 5 and FIG. 6 are each a perspective view of a locking member of the auto lock connector in the first embodiment in FIG. 1;

FIG. 7 is a side view of the locking member of the auto lock connector in the first embodiment in FIG. 1;

FIG. 8 is a perspective view of an auto lock connector in the second embodiment in accordance with the present invention, shown with a circuit unit;

FIG. 9 is a cross-sectional view of the auto lock connector in the second embodiment in FIG. 8;

FIG. 10 and FIG. 11 are each a perspective view of a locking member of the auto lock connector in the second embodiment in FIG. 8;

FIG. 12 is a side view of the locking member of the auto lock connector in the second embodiment in FIG. 8;

FIG. 13 is a perspective view of an auto lock connector in the third embodiment in accordance with the present invention, shown with a circuit unit;

FIG. 14 is an exploded view of the auto lock connector in the third embodiment in FIG. 13;

FIG. 15 is a top view of the auto lock connector in the third embodiment in FIG. 13;

FIG. 16 is a side view of the auto lock connector in the third embodiment in FIG. 13;

FIG. 17 is a cross-sectional view of the auto lock connector in the third embodiment in FIG. 13;

FIG. 18 is a partial cross-sectional view of the auto lock connector in the third embodiment in FIG. 13;

FIG. 19 is a perspective view of a locking member of the auto lock connector in the third embodiment in FIG. 13;

FIG. 20 is a side view of the locking member of the auto lock connector in the third embodiment in FIG. 13; and

FIG. 21 is a side view of the auto lock connector without the locking member in the third embodiment in FIG. 13.

### DETAILED DESCRIPTION OF THE PREFERRED EMBODIMENTS

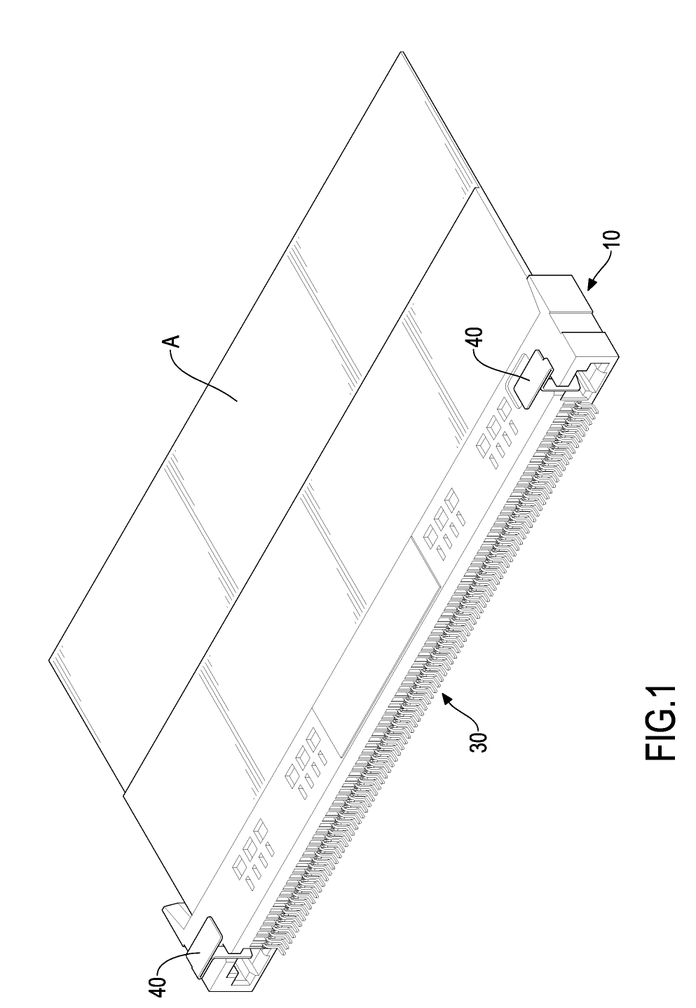

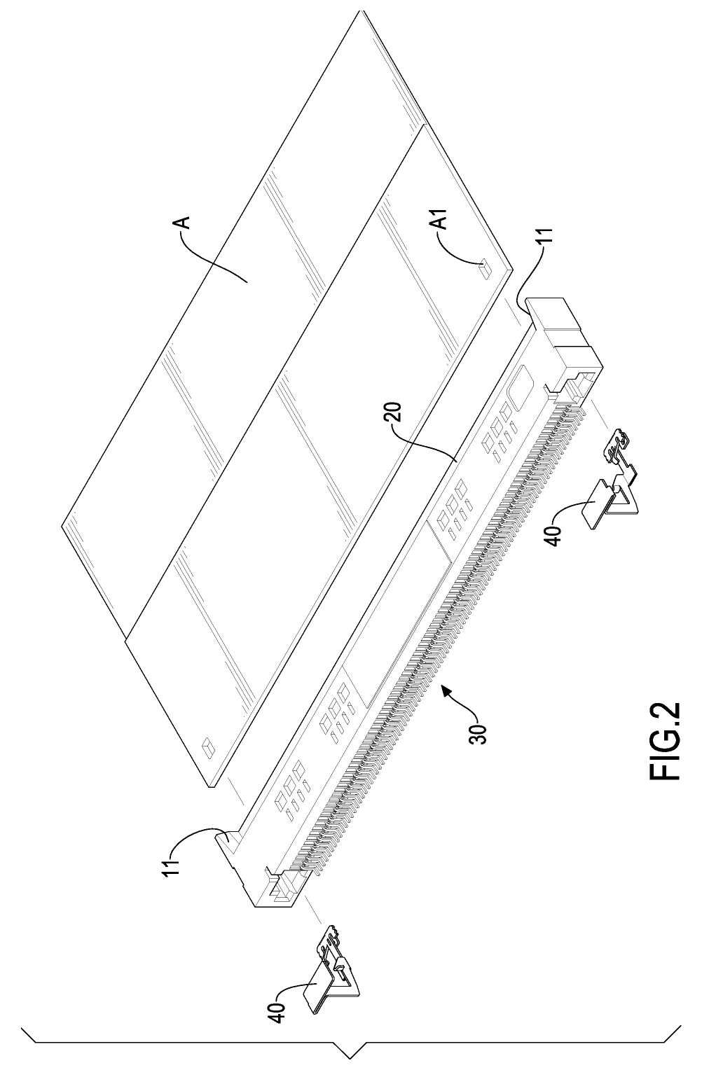

With reference to FIG. 1 and FIG. 2, an auto lock connector in accordance with the present invention is configured to connect a circuit unit A. The circuit unit A is a flexible flat cable or a flexible print circuit and comprises at least one aperture A1. The auto lock connector comprises a casing 10, an insertion port 20, a terminal assembly 30, and at least one locking member 40.

With reference to FIG. 2, the casing 10 forms a compartment and comprises two guiding surfaces 11. The insertion port 20 is formed on the casing 10 and between the two guiding surfaces 11, and the compartment communicates with the environment via the insertion port 20, so that the circuit unit A is capable of being inserted into the compartment of the casing 10 via the insertion port 20. The distance between the two guiding surfaces 11 gradually decreases in an inserting direction of the circuit unit A and is capable of guiding the circuit unit A into the center of the casing 10. The terminal assembly 30 is mounted on the casing 10 and configured to be electrically connected to the circuit unit A.

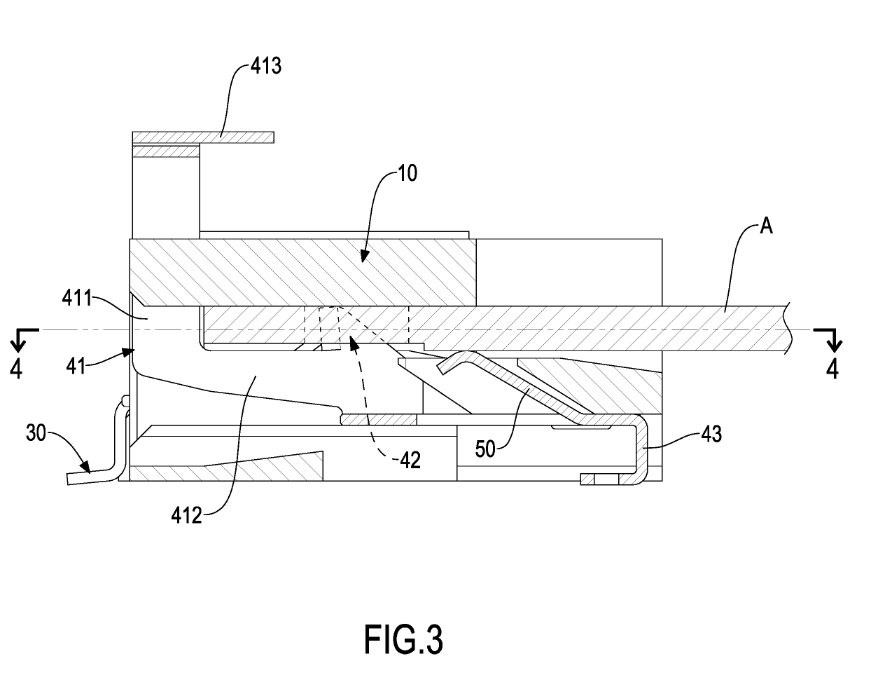

With reference to FIG. 3, the at least one locking member 40 is mounted in the casing 10, and each one of the at least one locking member 40 comprises at least one pushing part 41, at least one protrusion part 42, and at least one connection part 43.

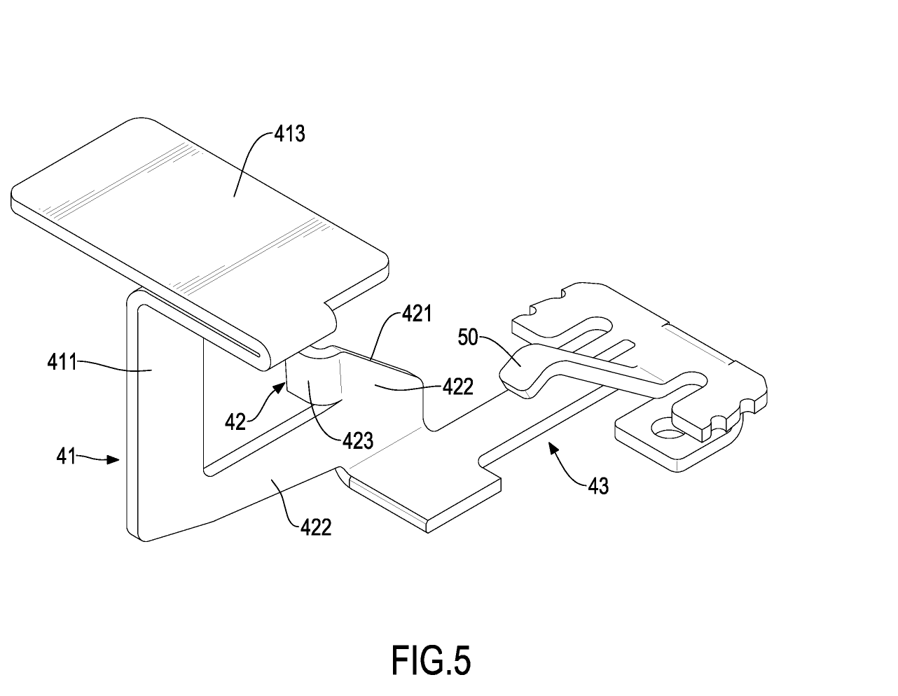

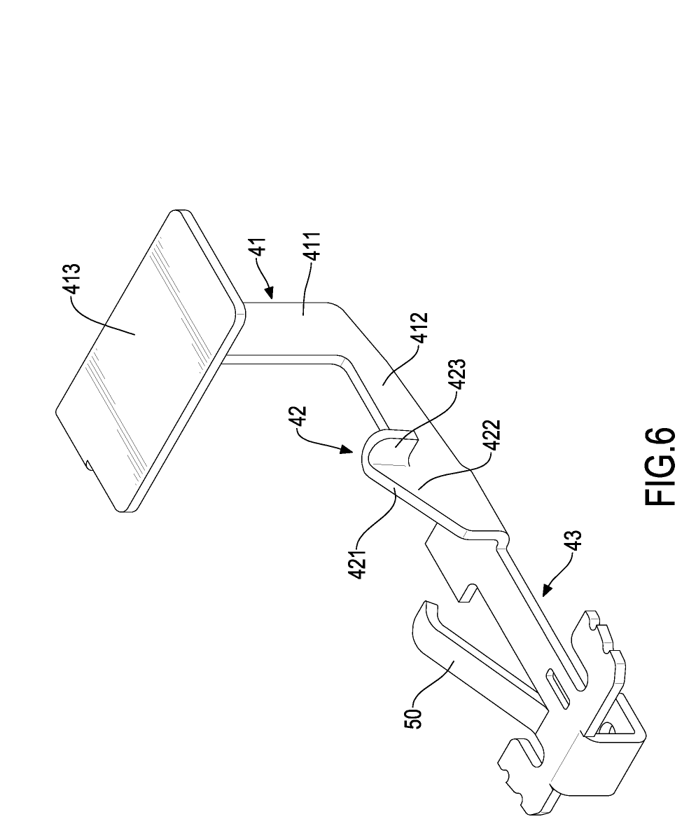

With reference to FIG. 3, FIG. 5, and FIG. 6, the at least one pushing part 41 protrudes from the casing 10, and each one of the at least one pushing part 41 comprises at least one pushing segment 411 and at least one horizontal segment 412. The at least one pushing segment 411is perpendicular to the top surface of the casing 10. The at least one horizontal segment 412 is perpendicular to the at least one pushing segment 411; in other words the horizontal segment 412 is parallel to the top surface of the casing 10.

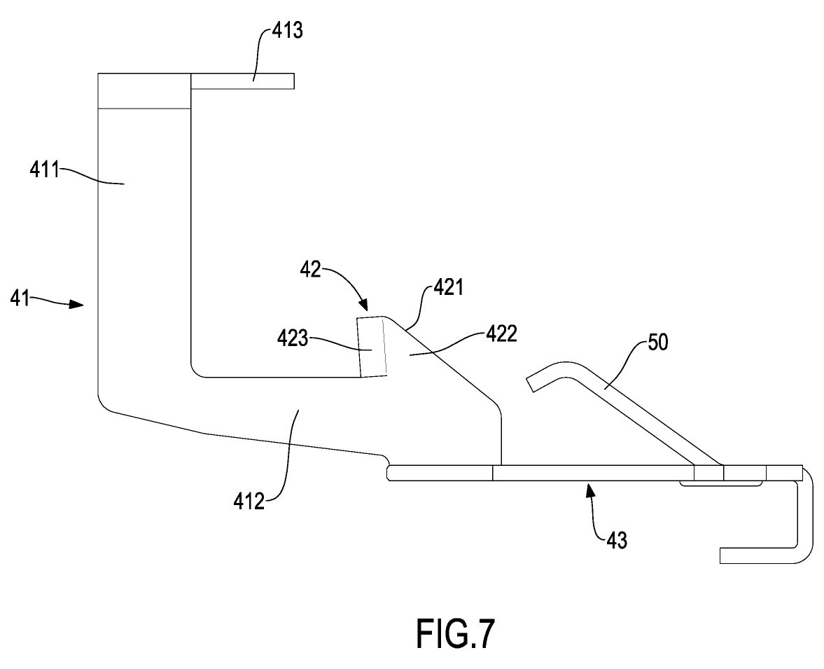

With reference to FIG. 7, the at least one protrusion part 42 is connected to the at least one pushing part 41 and protrudes toward the top surface of the casing 10. The at least one protrusion part 42 is capable of mounting in a respective one of the at least one aperture A1 of the circuit unit A. Precisely, each one of the at least one protrusion part 42 is connected to a respective one of the at least one horizontal segment 412 and forms a hook such that the at least one protrusion part 42 is configured to hook in the at least one aperture A1 of the circuit unit A. The angle between the horizontal segment 412 and a respective one of the at least one protrusion part 42 is less than 90 degrees, so that when the circuit unit A is forcibly pulled out, the circuit unit A will be stuck between the protrusion part 42 and the horizontal segment 412 and will not be depart from the compartment.

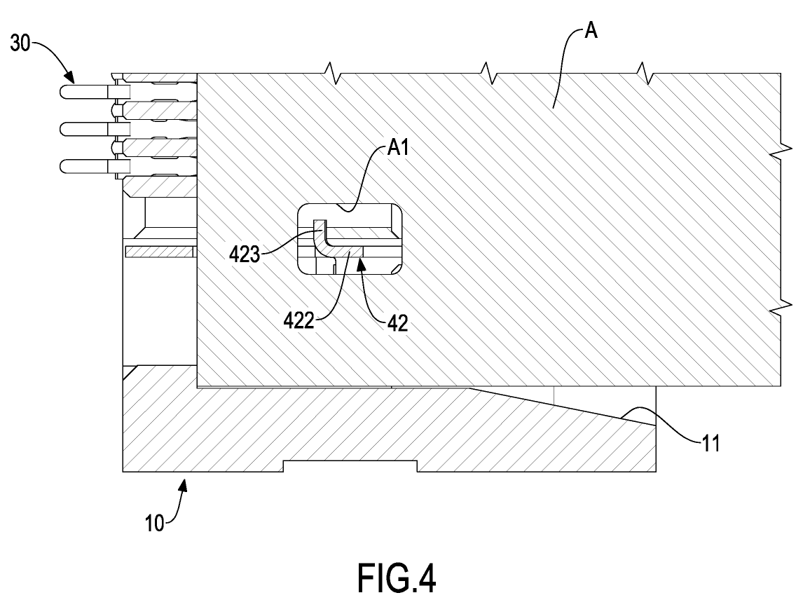

With reference to FIG. 4, each one of the at least one protrusion part 42 is a sheet and comprises an incline 421, an inserting segment 422, and a retaining segment 423. The incline 421 is inclined from a top surface of the protrusion part 42 toward a bottom surface of the insertion port 20 and forms on the inserting segment 422. The retaining segment 423 is connected to the inserting segment 422 and parallel to a side surface of a respective one of the apertures A1 of the circuit unit A. When the circuit unit A is forcibly pulled out, the retaining segment 423 will abut the side surface of a respective one of the apertures A1 of the circuit unit A, preventing a narrower side of the at least one protrusion part 42 from cutting the circuit unit A.

With reference to FIG. 5 to FIG. 7, the at least one connection part 43 is connected to the at least one pushing part 41 and the casing 10, and the at least one connection part 43 is elastic and thus configured to push the protrusion part 42 toward a top surface of the casing 10.

With reference to FIG. 5 to FIG. 7, in the first embodiment, the auto lock connector comprises two locking members 40. Each one of the locking members 40 comprises one pushing part 41, one protrusion part 42, and one connection part 43, but the quantities of the locking member 40, the pushing part 41, the protrusion part 42, and the connection part 43 are not limited thereto.

In the first embodiment, the auto lock connector further comprises two ground pieces 50. Each one of the ground pieces 50 is connected to one of the connection parts 43 and protruding from the said connection part 43 toward a respective one of the protrusion parts 42. When the circuit unit A is inserted into the casing 10 from the insertion port 20, the ground piece 50 abuts the circuit unit A. In the first embodiment, each one of the pushing parts 41 protrudes from the top surface of the casing 10 and comprises a press tab 413 disposed outside the casing 10 and parallel to the top surface of the casing 10.

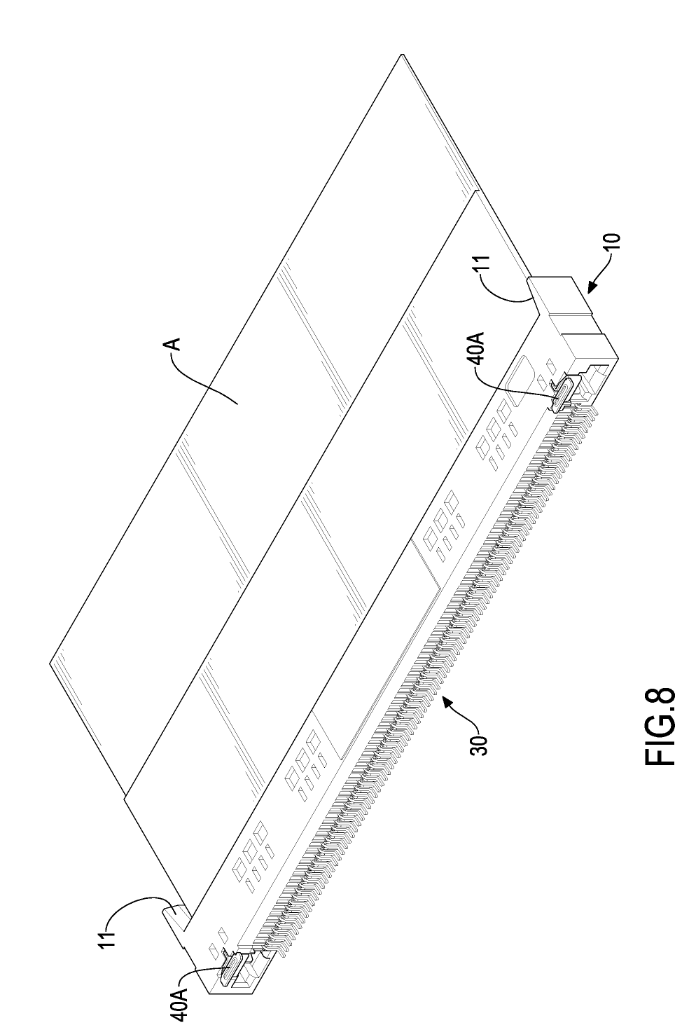

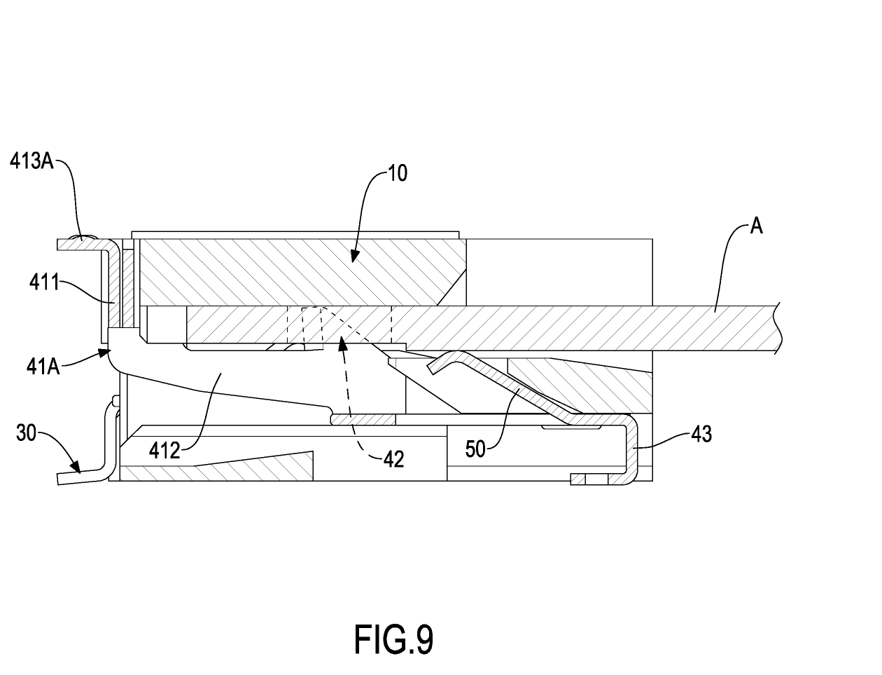

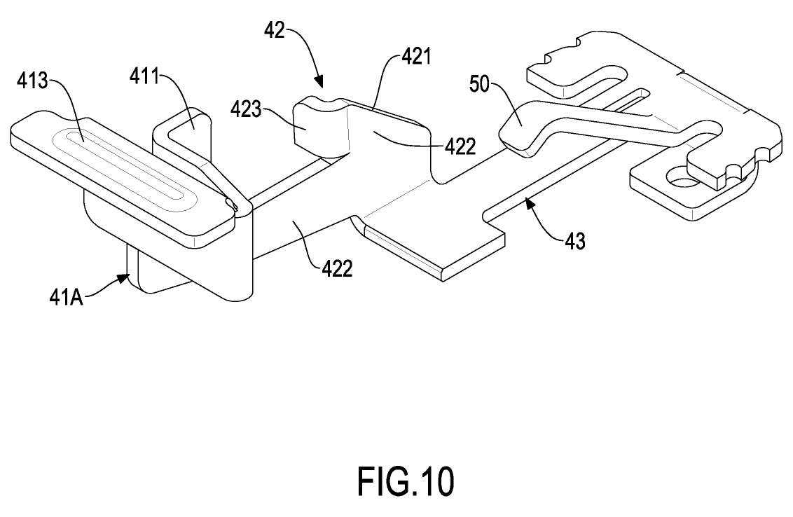

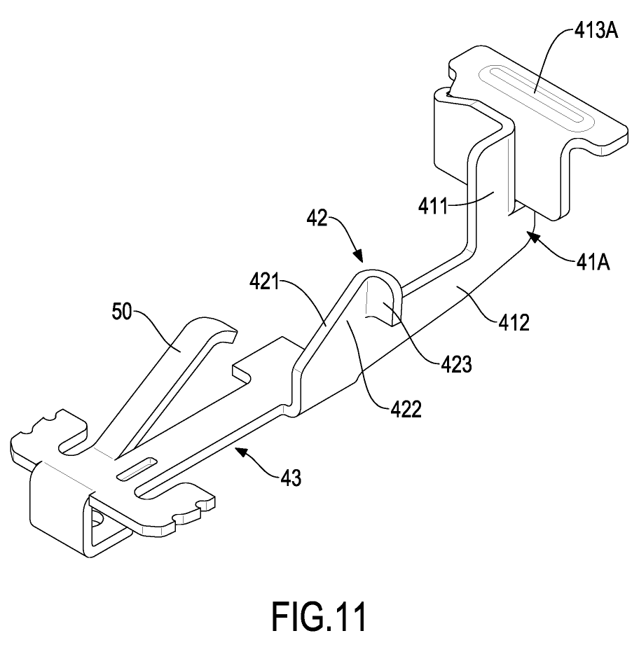

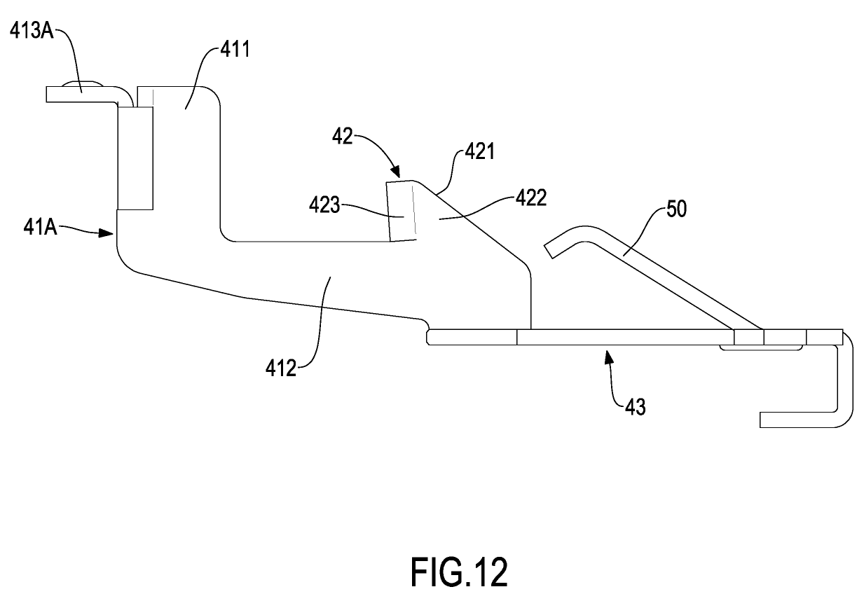

With reference to FIG. 8 to FIG. 12, the technical features of the second embodiment of the present invention are similar to the first embodiment, with the difference only in that, in the second embodiment, each one of the pushing parts 41 protrudes from a side surface of the casing 10 and the press tab 413 is disposed outside the casing 10 and parallel to the top surface of the casing 10.

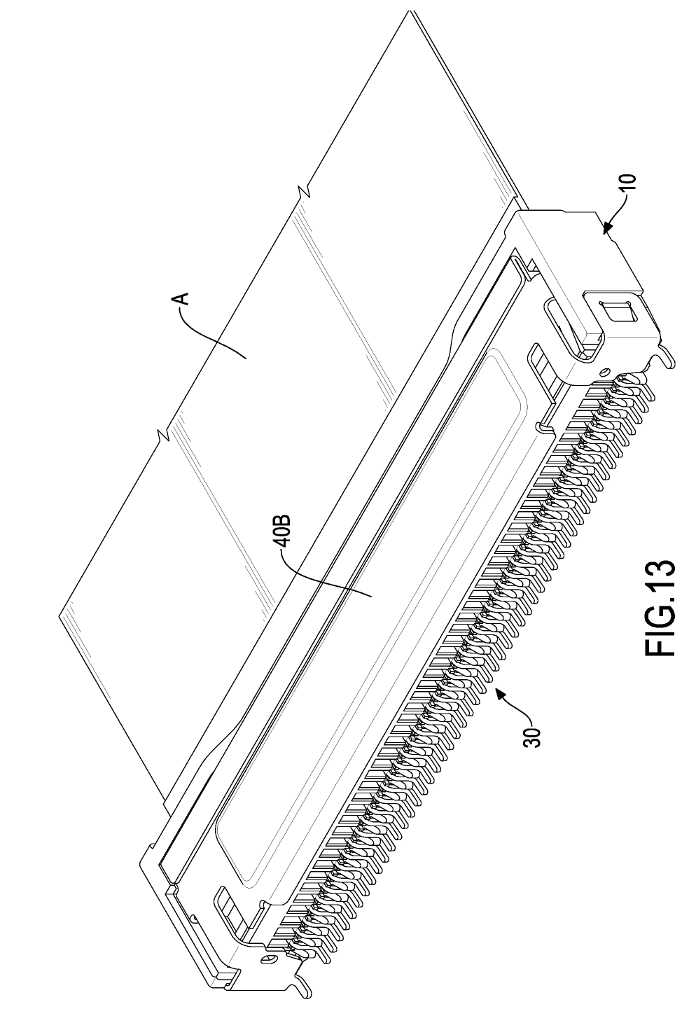

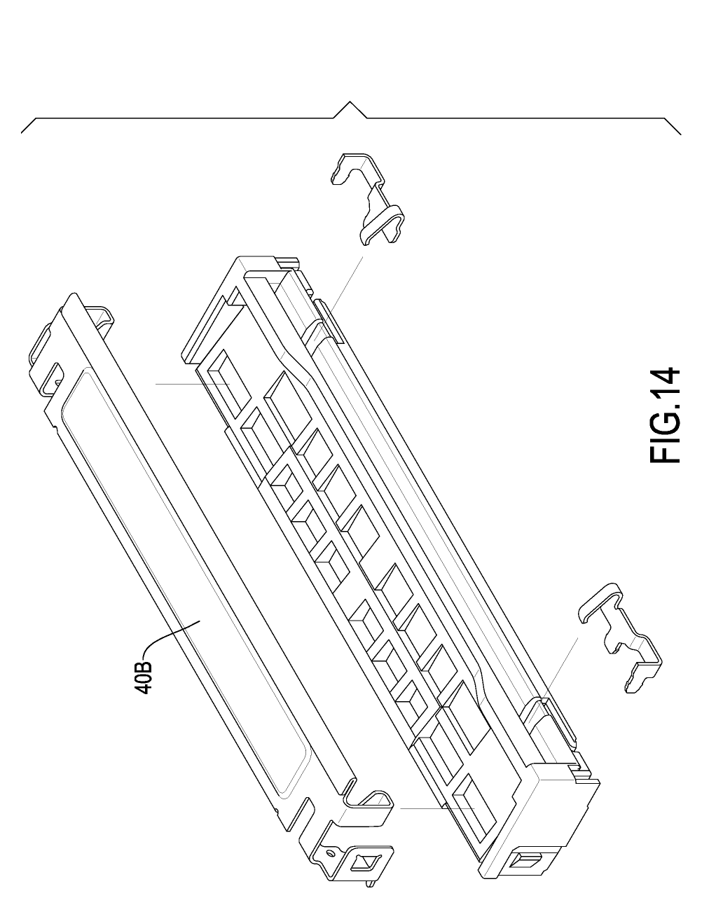

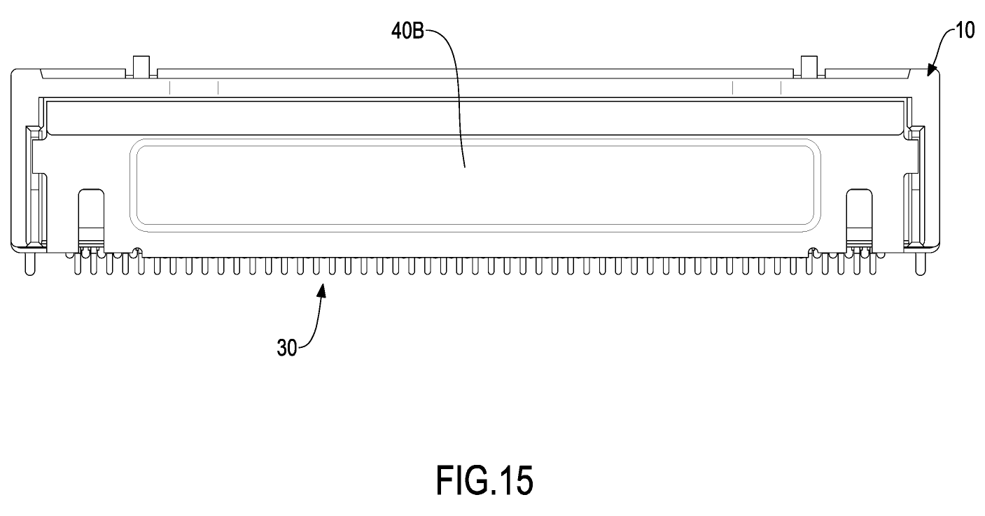

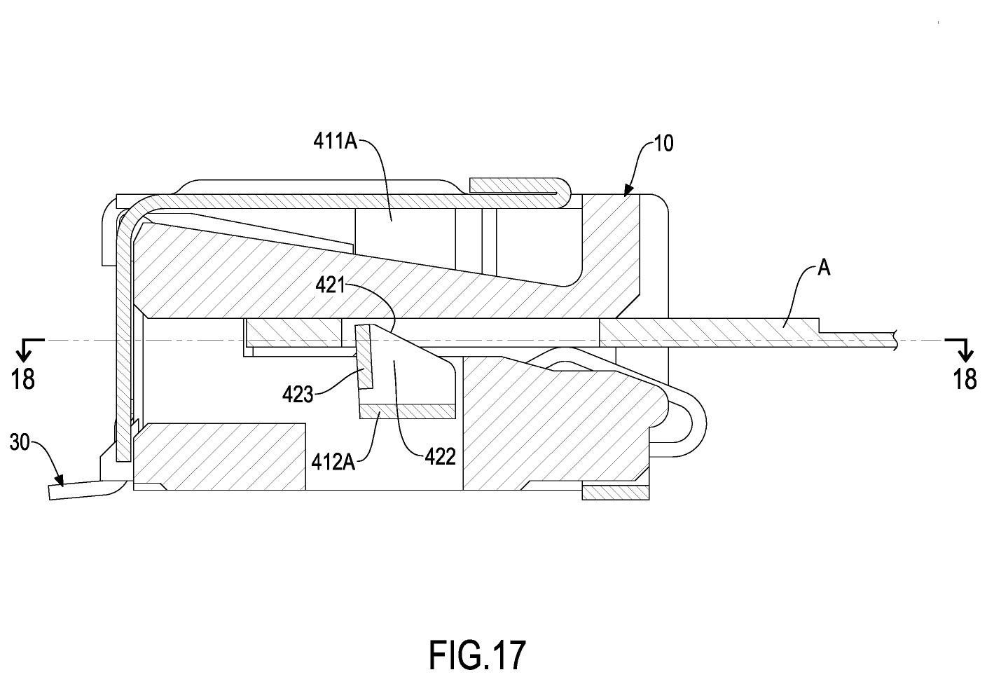

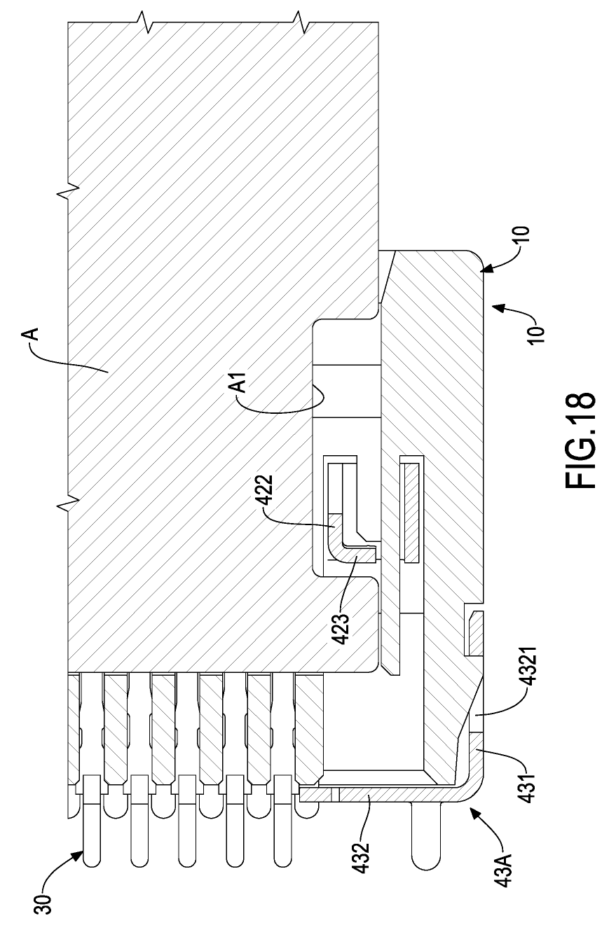

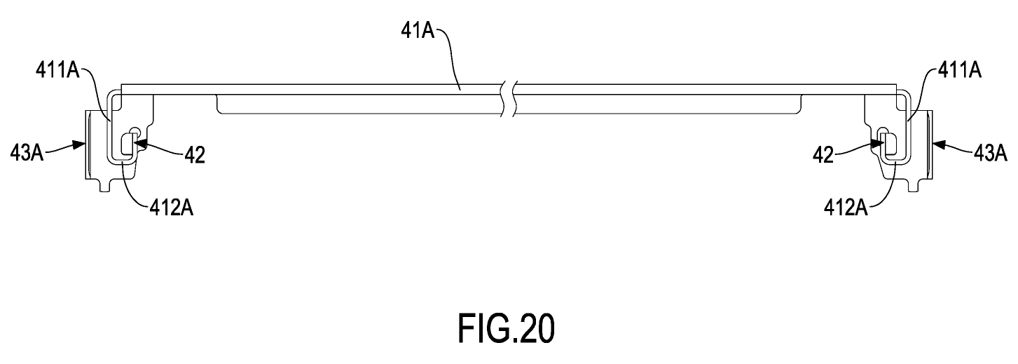

With reference to FIG. 13 to Fig.15, in the third embodiment, the auto lock connector comprises one locking member 40. With reference to FIG. 17, FIG. 18, and FIG. 20, the locking member 40 comprises one pushing part 41, two protrusion parts 42, and two connection parts 43. The pushing part 41 comprises two pushing segments and two horizontal segments 412, and the two horizontal segments 412 are respectively connected to the two protrusion parts 42.

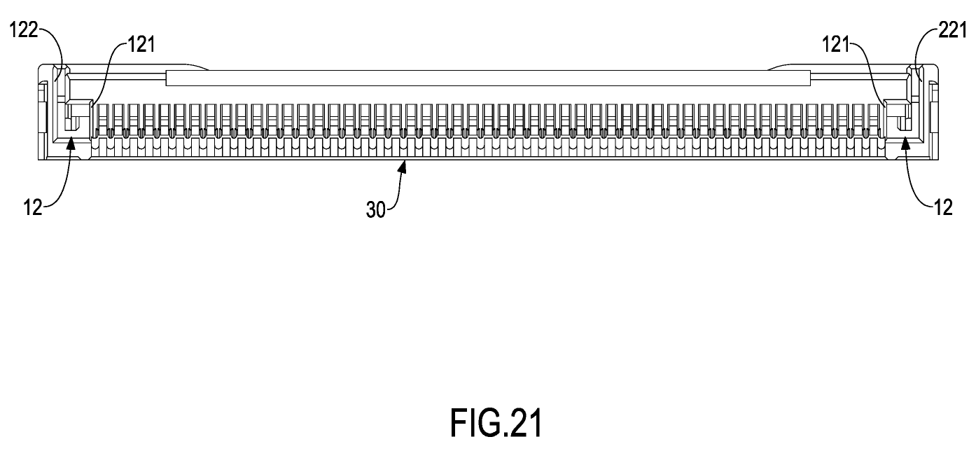

With reference to FIG. 21, in the third embodiment, the casing 10 further comprises two placement grooves 12 and two blocks 13. The placement grooves 12 are formed on the side surface of the casing 10, and each one of the placement grooves 12 comprises an inside vertical slot 121 and an outside vertical slot 122. Each one of the protrusion parts 42 is mounted in the inside vertical slots 121 of a respective one of the placement grooves 12. The outside vertical slot 122 communicates with the inside vertical slot 121, and each one of the pushing segments of the pushing part 41 protrudes from the outside vertical slot 122 of a respective one of the placement grooves 12. The two blocks 13 are mounted on an outer surface of the casing 10.

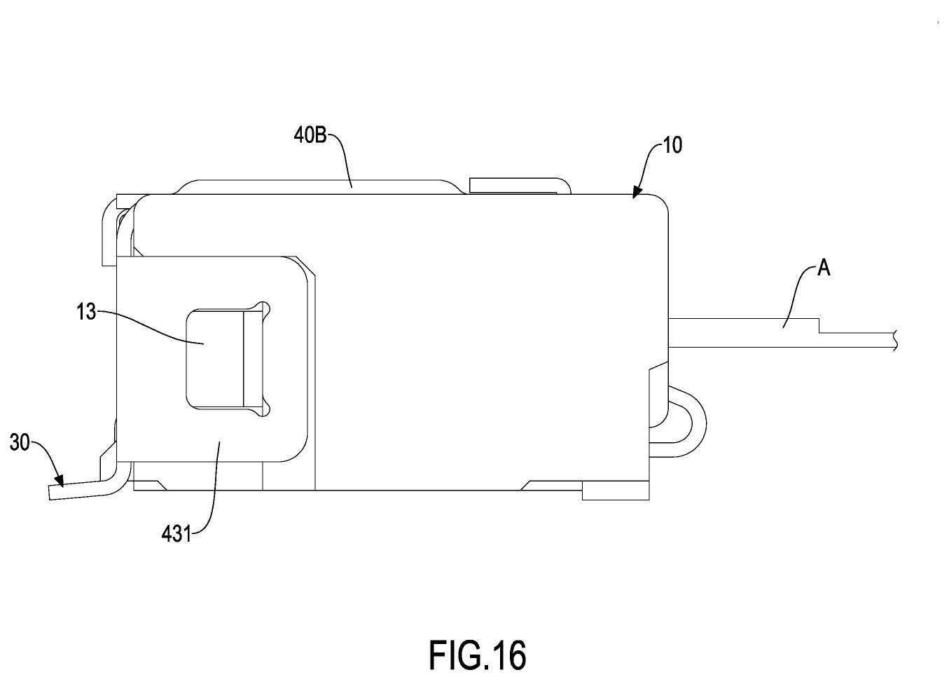

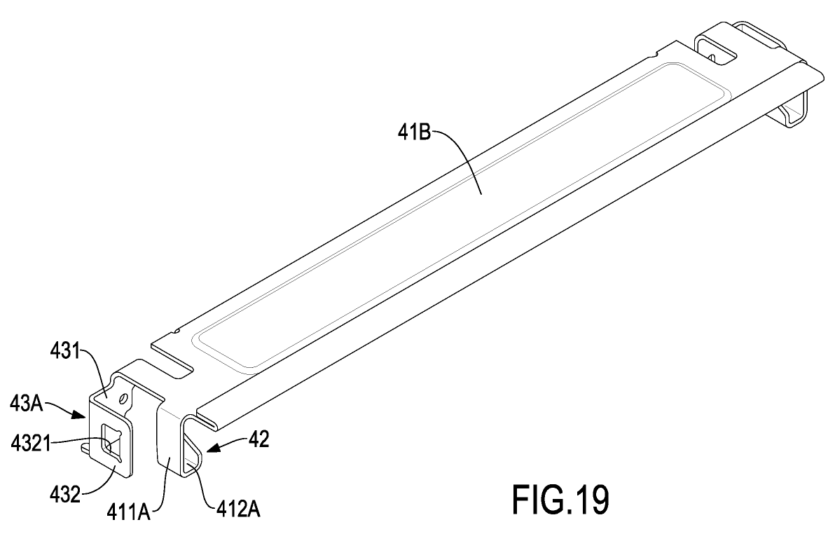

With reference to FIG. 16, FIG. 19 and FIG. 20, each one of the connection parts 43 of the locking member 40 includes two said connection parts 43, and each one of the connection parts 43 comprises an extension segment 431 and a fixed segment 432. The extension segment 431 is connected to the pushing part 41. The fixed segment 432 is connected to the extension segment 431 and comprises a hole 4321. Each one of the blocks 13 is capable of penetrating through the hole 4321 of a respective one of the connection parts 43, so that the locking member 40 is fixed on the casing 10.

When the circuit unit A is inserted into the casing 10 from the insertion port 20 along the inserting direction, the circuit unit A pushes the at least one protrusion part 42 along the incline 421 away from the top surface of the casing 10 until the at least one protrusion part 42 corresponds to the at least one aperture A1 of the circuit unit A. Then, each one of the at least one protrusion part 42 is inserted into a respective one of the at least one aperture A1 of the circuit unit A, so that the circuit unit A is unable to be removed from the casing 10.

When the at least one pushing part 41 of each one of the at least one locking member 40 is pushed, the at least one protrusion part 42 moves away from the top surface of the casing 10 and is disengaged from the at least one aperture A1 of the circuit unit A, so that the circuit unit A is capable of being pulled out from the casing 10.

The advantage of the present invention is that when the circuit unit A is inserted into the casing 10, the circuit unit A will be locked in the casing 10 due to the recovery elasticity of the connection part 43 to achieve automatic locking. Meanwhile, to prevent the circuit unit A being pulled by external force and leaving the casing 10 or damaging the circuit unit A when the circuit unit A is locked, the present invention also designs the angle between the horizontal segment 412 and a respective one of the at least one protrusion part 42 less than 90 degrees and has a retaining segment 423 to protect the circuit unit A. In terms of unlocking the circuit unit A, the user only needs to press the at least one pushing part 41 to disengage the at least one protrusion part 42 from the at least one aperture A1 of the circuit unit A, and pull out the circuit unit A. Whether installing or releasing the circuit unit A, the operation is simple and can reduce the time spent on disassembly.

In the description of the present invention, the orientation or positional relationships indicated by “top”, “bottom”, “upward”, etc. are based on the orientation or positional relationships shown in the figures and are not a limiting condition of the present invention.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. An auto lock connector configured to connect a circuit unit, the circuit unit being a flexible flat cable or a flexible print circuit, and the circuit unit comprising at least one aperture; the auto lock connector comprising:
a casing forming a compartment;
an insertion port formed on the casing, and the compartment communicating with the environment via the insertion port;
a terminal assembly mounted on the casing and configured to be electrically connected to the circuit unit;
at least one locking member mounted in the casing, and each one of the at least one locking member comprising:
at least one pushing part protruding from the casing;
at least one protrusion part connected to the at least one pushing part, protruding upward, and capable of mounting in a respective one of the at least one aperture of the circuit unit; each one of the at least one protrusion part comprising:
an incline inclined from a top surface of the protrusion part toward a bottom surface of the insertion port;
at least one connection part connected to the at least one pushing part and the casing, and the at least one connection part being elastic and thus configured to push the protrusion part toward a top surface of the casing;
wherein, when the circuit unit is inserted into the casing from the insertion port, each one of the at least one protrusion part is inserted into a respective one of the at least one aperture of the circuit unit, so that the circuit unit is non-removeable from the casing;
when the at least one pushing part of each one of the at least one locking member is pushed, the at least one protrusion part moves away from the top surface of the casing and is disengaged from the at least one aperture of the circuit unit, so that the circuit unit is capable of being pulled out from the casing.

2. The auto lock connector as claimed in claim 1, wherein, each one of the at least one protrusion part forms a hook such that the protrusion part is configured to hook in the at least one aperture of the circuit unit.

3. The auto lock connector as claimed in claim 1, wherein,
each one of the at least one pushing part comprises:
at least one pushing segment perpendicular to the top surface of the casing;
at least one horizontal segment perpendicular to the pushing segment, and an angle between the horizontal segment and a respective one of the at least one protrusion part being less than 90 degrees.

4. The auto lock connector as claimed in claim 2, wherein,
each one of the at least one pushing part comprises:
at least one pushing segment perpendicular to the top surface of the casing;
at least one horizontal segment perpendicular to the pushing segment, and the at least one protrusion part connected to a respective one of the at least one horizontal segment to form the hook; an angle between the horizontal segment and a respective one of the at least one protrusion part being less than 90 degrees.

5. The auto lock connector as claimed in claim 1, wherein, each one of the at least one protrusion part is a sheet and comprises:
an inserting segment, the incline formed on the inserting segment; and
a retaining segment connected on the inserting segment and parallel to a side surface of a respective one of the at least one aperture of the circuit unit.

6. The auto lock connector as claimed in claim 4, wherein, each one of the at least one protrusion part is a sheet and comprises:
an inserting segment, the incline formed on the inserting segment; and
a retaining segment connected on the inserting segment and parallel to a side surface of a respective one of the at least one aperture of the circuit unit.

7. The auto lock connector as claimed in claim 1, wherein, the casing comprises two guiding surfaces, the insertion port is located between the two guiding surfaces; a distance between the two guiding surfaces gradually decreases in an inserting direction of the circuit unit.

8. The auto lock connector as claimed in claim 6, wherein, the casing comprises two guiding surfaces, the insertion port is located between the two guiding surfaces; a distance between the two guiding surfaces gradually decreases in an inserting direction of the circuit unit.

9. The auto lock connector as claimed in claim 1, further comprising:
a ground piece, the ground piece abutting the circuit unit when the circuit unit is inserted into the casing from the insertion port.

10. The auto lock connector as claimed in claim 8, further comprising:
a ground piece, the ground piece abutting the circuit unit when the circuit unit is inserted into the casing from the insertion port.

11. The auto lock connector as claimed in claim 9, wherein, the ground piece is connected to the connection part and protrudes from the connection part toward the protrusion part.

12. The auto lock connector as claimed in claim 10, wherein, the ground piece is connected to the connection part and protrudes from the connection part toward the protrusion part.

13. The auto lock connector as claimed in claim 1, wherein, the pushing part protrudes from a top surface of the casing and comprises:
a press tab disposed outside the casing and parallel to the top surface of the casing.

14. The auto lock connector as claimed in claim 12, wherein, the pushing part protrudes from a top surface of the casing and comprises:
a press tab disposed outside the casing and parallel to the top surface of the casing.

15. The auto lock connector as claimed in claim 1, wherein, the pushing part protrudes from a side surface of the casing and comprises:
a press tab disposed outside the casing and parallel to a top surface of the casing.

16. The auto lock connector as claimed in claim 12, wherein, the pushing part protrudes from a side surface of the casing and comprises:
a press tab disposed outside the casing and parallel to a top surface of the casing.

17. The auto lock connector as claimed in claim 1, wherein, the casing comprises:
at least one placement groove formed on a side surface of the casing, and each one of the at least one placement groove comprising:
an inside vertical slot, each one of the at least one protrusion part mounted in the inside vertical slot of a respective one of the at least one placement groove;
an outside vertical slot communicating with the inside vertical slot, each one of the at least one pushing part protruding from the outside vertical slot of a respective one of the at least one placement groove.

18. The auto lock connector as claimed in claim 12, wherein, the casing comprises:
at least one placement groove formed on a side surface of the casing, and each one of the at least one placement groove comprising:
an inside vertical slot, each one of the at least one protrusion part mounted in the inside vertical slot of a respective one of the at least one placement groove;
an outside vertical slot communicating with the inside vertical slot, each one of the at least one pushing part protruding from the outside vertical slot of a respective one of the at least one placement groove.

19. The auto lock connector as claimed in claim 1, wherein,
the casing comprises:
two blocks mounted on an outer surface of the casing;
the at least one connection part of each one of the at least one locking member includes two said connection parts, and each one of the two connection parts comprises:
an extension segment connected to the at least one pushing part;
a fixed segment connected to the extension segment and comprising:
a hole, each one of the blocks being capable of penetrating through the hole of a respective one of the two connection parts.

20. The auto lock connector as claimed in claim 18, wherein,
the casing comprises:
two blocks mounted on an outer surface of the casing;
the at least one connection part of each one of the at least one locking member includes two said connection parts, and each one of the two connection parts comprises:
an extension segment connected to the at least one pushing part;
a fixed segment connected to the extension segment and comprising:
a hole, each one of the blocks being capable of penetrating through the hole of a respective one of the two connection parts.
